(19) United States
(12) Patent Application Publication
(10) Pub. No.: US 2020/0325061 A1
(43) Pub. Date: Oct. 15, 2020

(54) BEAD REMOVAL APPARATUSES AND METHODS FOR SEPARATING BEADS FROM GLASS SHEETS WITH GLASS ENGAGING UNITS

(71) Applicant: CORNING INCORPORATED, CORNING, NY (US)

(72) Inventors: Suzette Kimmel, Wayland, NY (US); Mark Thomas Massaro, Murray, KY (US); Joel David Millett, Horseheads, NY (US); Robert Richard Quiel, Horseheads, NY (US)

(21) Appl. No.: 16/093,806

(22) PCT Filed: Apr. 18, 2017
(86) PCT No.: PCT/US2017/028042

§ 371 Date: Oct. 15, 2018

Related U.S. Application Data
(60) Provisional application No. 62/324,049, filed on Apr. 18, 2016.

(51) Int. Cl. C03B 33/02; C03B 17/06; C03B 33/07; B65G 49/06

(52) U.S. Cl. CPC C03B 33/0215; C03B 17/064; B65G 2249/04; B65G 49/063; B65G 49/061; C03B 33/07

(57) ABSTRACT

Bead removal apparatus and methods of separating beads from glass sheets with glass engaging units are disclosed. The bead removal apparatus includes a forming body from which a continuous glass ribbon is drawn in a draw direction and a bead removal station adjacent to and laterally offset from the forming body. The bead removal station includes a heating element configured to heat a desired line of bead separation of a glass sheet to a temperature within a range of about 400° C. to about 600° C., and a crack initiation device configured to initiate a crack in the glass sheet at the desired line of bead separation. The bead removal apparatus further includes a glass engaging unit configured to move the glass sheet from the continuous glass ribbon to the bead removal station.

This application claims the benefit of priority to U.S. Provisional Application No. 62/324049, filed Apr. 18, 2016, the content of which is incorporated herein by reference in its entirety.

### BACKGROUND

### Field

The present specification generally relates to glass manufacturing apparatuses and methods, and more specifically, to bead removal apparatuses and methods for separating beads from glass sheets with glass engaging units at desired lines of bead separation, after the glass sheets are sectioned from continuous glass ribbons.

### Technical Background

Continuous glass ribbons may be formed by processes such as the fusion draw process, the slot draw process, float process, or other similar downdraw processes. The fusion draw process yields continuous glass ribbons which have surfaces with superior flatness and smoothness when compared to glass ribbons produced by other methods. Individual glass sheets sectioned from continuous glass ribbons formed by the fusion draw process can be used in a variety of devices including flat panel displays, touch sensors, photovoltaic devices, and other electronic applications. However, before the glass sheets obtained from the continuous glass ribbon can be used, beads from the glass sheet are typically removed.

Usually, glass sheets are de-beaded by scoring and breaking the beads off the glass sheet. While this method may be employed for glass sheets having low compressive stresses, these techniques have proved ineffective for strengthened glass laminates, having higher compressive stresses. For this, and other reasons, de-beading of glass sheets in this manner was found to be problematic.

Accordingly, a need exists for alternative apparatuses and methods that facilitate de-beading of glass sheets.

### SUMMARY

According to one embodiment, a bead removal apparatus includes a forming body from which a continuous glass ribbon is drawn in a draw direction, and a bead removal station adjacent to and laterally offset from the forming body. The bead removal station includes a heating element configured to heat a desired line of bead separation of a glass sheet to a temperature within a range of about 400° C. to about 600° C., and a crack initiation device configured to initiate a crack in the glass sheet at the desired line of bead separation. The bead removal apparatus further includes a glass engaging unit configured to move the glass sheet from the continuous glass ribbon to the bead removal station.

In another embodiment, a method of separating at least one bead from a glass sheet includes drawing molten glass in a draw direction to form a continuous glass ribbon at a forming body, engaging the continuous glass ribbon with a glass engaging unit, and separating the glass sheet from the continuous glass ribbon such that the glass sheet is engaged with the glass engaging unit. The method further includes moving the glass sheet to a bead removal station while glass sheet is engaged with the glass engaging unit, the bead removal station being adjacent to and laterally offset from the forming body, and separating the at least one bead from the glass sheet at a desired line of bead separation at the bead removal station while the glass sheet is engaged with the glass engaging unit.

In another embodiment, a method of separating at least one bead from a glass sheet includes drawing molten glass in a draw direction to form a continuous glass ribbon at a forming body, engaging the continuous glass ribbon with a glass engaging unit, and separating the glass sheet from the continuous glass ribbon such that the glass sheet is engaged with the glass engaging unit. The method further includes moving the glass sheet to a bead removal station while the glass sheet is engaged with the glass engaging unit, the bead removal station being adjacent to and laterally offset from the forming body, applying heat selectively to the glass sheet with a bead removal heating apparatus at the bead removal station, the bead removal heating apparatus comprising a heating element to heat the glass sheet to a temperature within a range of about 400° C. to about 600° C., the heating element placed substantially parallel to the draw direction, and initiating a crack in the glass sheet at a desired line of bead separation with a crack initiation device placed above the heating element at the bead removal station. The desired line of bead separation extends substantially parallel to an edge of the glass sheet and the at least one bead is a longitudinal portion of the glass sheet extending width wise from the edge of the glass sheet to the desired line of bead separation.

Additional features and advantages of the embodiments described herein are set forth in the detailed description, the claims, and the appended drawings.

The foregoing general description and the following detailed description provide various embodiments and provide an overview or framework for understanding the nature and character of the claimed subject matter. The accompanying drawings provide a further understanding of the various embodiments, and are incorporated into and constitute a part of this specification. The drawings and the description explain the principles and operations of the claimed subject matter.

### BRIEF DESCRIPTION OF THE DRAWINGS

FIG. 1 schematically depicts a bead removal apparatus including a glass manufacturing apparatus having a forming body, a bead removal station, and a glass engaging unit, according to one or more embodiments shown and described herein;

FIG. 2 schematically depicts a side view of a glass manufacturing apparatus from which a continuous glass ribbon is drawn, according to one or more embodiments shown and described herein;

FIG. 3 schematically depicts a front view of the glass manufacturing apparatus of FIG. 2 including a forming body, with the continuous glass ribbon engaged with the glass engaging unit, according to one or more embodiments shown and described herein;

FIG. 4 schematically depicts a view of the glass engaging unit engaged with a glass sheet, according to one or more embodiments shown and described herein;

FIG. 5 schematically depicts the bead removal station including a bead removal heating apparatus and a crack initiation device, according to one or more embodiments shown and described herein;

FIG. 6 schematically depicts a detailed view of the bead removal heating apparatus and the crack initiation device of the bead removal station, according to one or more embodiments shown and described herein; and

FIG. 7 schematically depicts a detailed view of the bead removal heating apparatus and the crack initiation device of the bead removal station, according to one or more embodiments shown and described herein; and

FIG. 8 depicts a flowchart of a method of removing at least one bead from the glass sheet, according to one or more embodiments shown and described herein.

### DETAILED DESCRIPTION

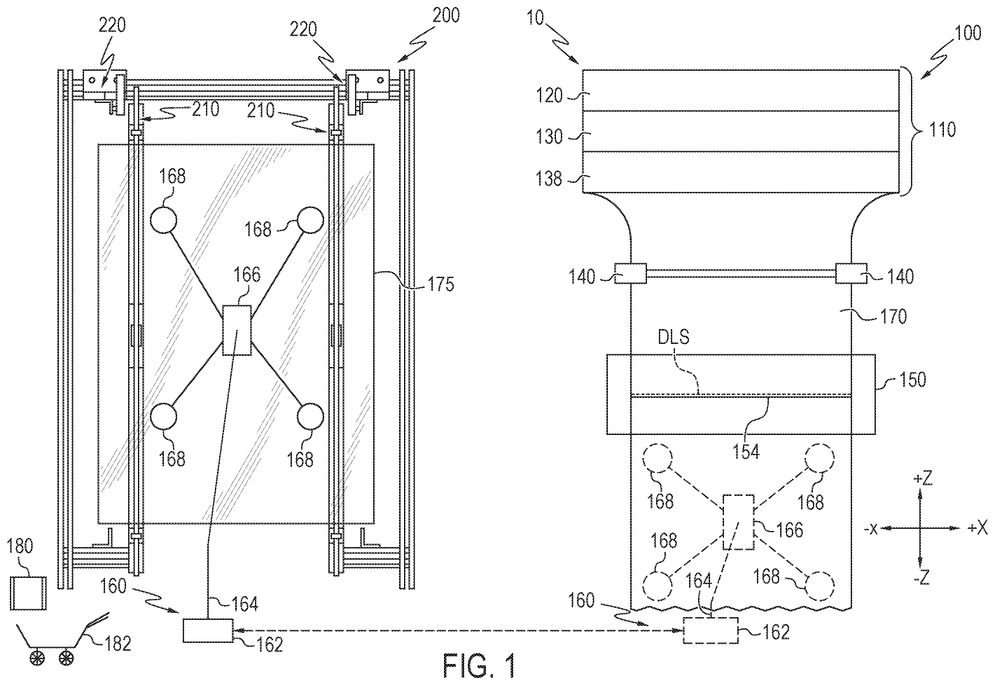

Reference will now be made in detail to embodiments of bead removal apparatuses and methods for separating beads from glass sheets with glass engaging units at desired lines of bead separation, examples of which are illustrated in the accompanying drawings. Whenever possible, the same reference numerals will be used throughout the drawings to refer to the same or like parts. FIG. 1 schematically depicts one embodiment of a bead removal apparatus for separating beads at a desired line of separation from a glass sheet. The bead removal apparatus includes a forming body from which a continuous glass ribbon is drawn, a glass engaging unit, and a bead removal station adjacent to and laterally offset from the forming body, the bead removal station including a bead removal heating apparatus and a crack initiation device. The glass engaging unit separates the glass sheet from the continuous ribbon beneath the forming body, and moves the glass sheet to the bead removal station for separating the beads from the glass sheet. The bead removal apparatuses for separating beads from glass sheets and methods of using the same are described in more detail herein with specific reference to the appended figures.

Coordinate axes are included in the drawings to provide a frame of reference for various components of the continuous glass ribbon fabrication apparatuses and methods described herein. As used herein, a “lateral” or “across-the-draw” direction is defined as the positive X or negative X direction of the coordinate axes shown in the drawings. A “downstream” or “draw” direction is defined as the negative Z direction of the coordinate axes shown in the drawings. An “upstream” direction is defined as the positive Z direction of the coordinate axes shown in the drawings. A “depth” is defined in the positive Y or negative Y direction of the coordinate axes shown in the drawings.

As used herein the term “average coefficient of thermal expansion” means the linear coefficient of thermal expansion averaged over a temperature range of 20° C.-300° C.

While the apparatuses and methods described herein are used to separate beads from glass sheets that are obtained from continuous ribbons, formed by the fusion downdraw process, embodiments are not limited thereto. The apparatuses and methods described herein may be used to separate beads obtained from individual glass sheets or individual glass sections. Additionally, the apparatuses and methods described herein may be used to separate beads from glass sheets that are laminated, non-laminated, continuous, or glass sheets obtained from non-continuous glass ribbons formed from the slot draw process, another downdraw process, the float process, or another glass ribbon manufacturing process.

Referring to FIG. 1 by way of example, bead removal apparatus 10 is depicted. The bead removal apparatus 10 includes a glass manufacturing apparatus 100 for forming a continuous glass ribbon 170 drawn from a forming body 110, a glass engaging unit 160, and a bead removal station 200. The glass engaging unit 160 is shown in conjunction with the bead removal station 200. The bead removal station 200 is placed adjacent to and laterally offset from the forming body 110. The bead removal station 200 further includes a bead removal heating apparatus 210 and a crack initiation device 220. The glass engaging unit 160 includes a translatable body 162, at least one arm 164 that extends from the translatable body 162, and at least one suction device 168 placed at a distal end of the at least one arm 164. Each of the glass manufacturing apparatus 100, the glass engaging unit 160, and the bead removal station 200 will be described in further detail below.

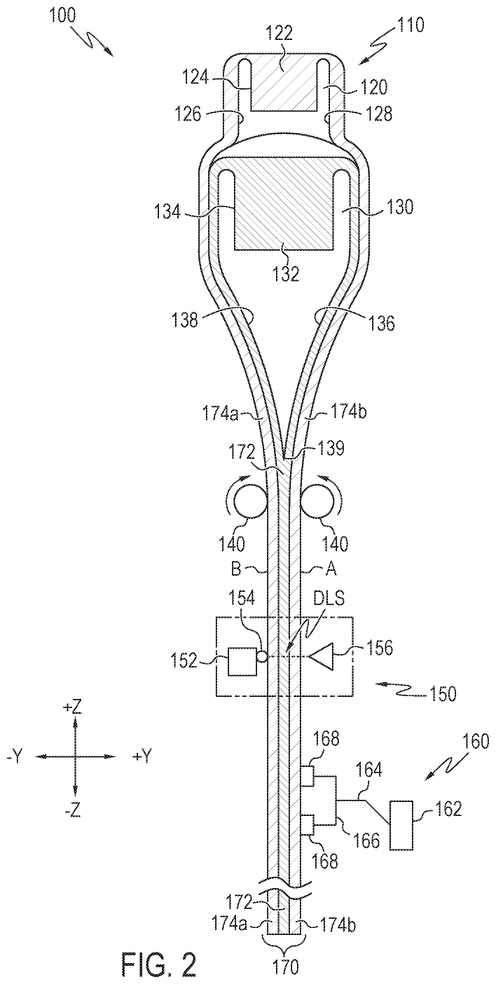

Referring now to FIG. 2, in addition to the forming body 110, the glass manufacturing apparatus 100 further includes a plurality of pulling rolls 140 and a translatable separation initiation unit 150. Additionally, a glass engaging unit 160 is also shown in conjunction with the glass manufacturing apparatus 100.

Still referring to FIG. 2, the forming body 110 includes an upper isopipe 120 positioned over a lower isopipe 130. The upper isopipe 120 includes a trough 124 into which a molten glass cladding composition 122 is fed from a melter (not shown). Similarly, the lower isopipe 130 includes a trough 134 into which a molten glass core composition 132 is fed from a melter (not shown). In the embodiments, described herein, the molten glass core composition 132 has an average coefficient of thermal expansion CTE_{core} which is greater than the average coefficient of thermal expansion CTE_{clad} of the molten glass cladding composition 122.

Still referring to FIG. 2, as the molten glass core composition 132 fills the trough 134, it overflows the trough 134 and flows over the outer forming surfaces 136, 138 of the lower isopipe 130. The outer forming surfaces 136, 138 of the lower isopipe 130 converge at a root 139. Accordingly, the molten glass core composition 132 flowing over the outer forming surfaces 136, 138 rejoins at the root 139 of the lower isopipe 130 thereby forming a glass core layer 172 of the continuous glass ribbon 170.

Simultaneously, the molten glass cladding composition 122 overflows the trough 124 formed in the upper isopipe 120 and flows over outer forming surfaces 126, 128 of the upper isopipe 120. The molten glass cladding composition 122 is outwardly deflected by the upper isopipe 120 such that the molten glass cladding composition 122 flows around the lower isopipe 130 and contacts the molten glass core composition 132 flowing over the outer forming surfaces 136, 138 of the lower isopipe 130, fusing to the molten glass core composition 132 and glass cladding layers 174a, 174b around the glass core layer 172 of the continuous glass ribbon 170.

As noted above, the molten glass core composition 132 generally has an average coefficient of thermal expansion CTE_{core} which is greater than the average coefficient of thermal expansion CTE_{clad} of the molten glass cladding composition 122. Accordingly, as the glass core layer 172 and the glass cladding layers 174a, 174b cool, the difference in the coefficients of thermal expansion of the glass core layer 172 and the glass cladding layers 174a, 174b cause a compressive stresses to develop in the glass cladding layers 174a, 174b. The compressive stress increases the strength of the resulting laminated glass article without an ion-exchange treatment or a thermal tempering treatment.

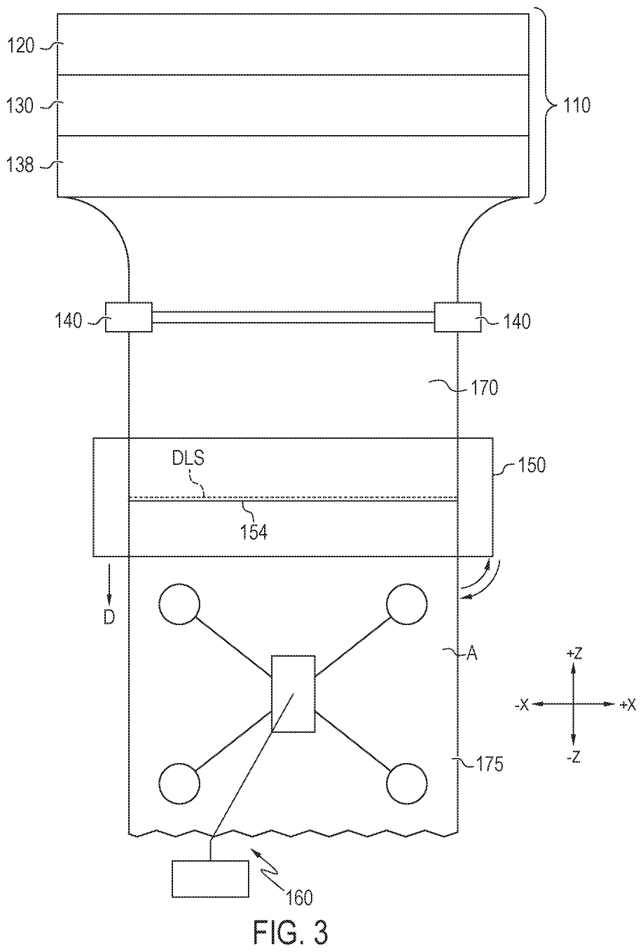

Still referring to FIG. 2, the plurality of pulling rolls 140 are arranged in opposing pairs and are counter-rotating. That is, a first pulling roll of the plurality of pulling rolls 140 is positioned adjacent to a first side of the continuous glass ribbon 170 (the “A” surface or a first side of the continuous glass ribbon 170) and rotates in a direction opposite a second pulling roll of the plurality of pulling rolls 140 positioned across from the first pulling roll and adjacent to a second side of the continuous glass ribbon 170 (the “B” surface or the second side of the continuous glass ribbon 170). The continuous glass ribbon 170 is positioned between opposing pairs of pulling rolls so that the pulling rolls contact and pinch the continuous glass ribbon 170 at the edge portions of the glass ribbon, as depicted in FIGS. 2 and 3.

Referring once again to FIG. 2, the plurality of pulling rolls 140 are driven by motors and apply a downward force to the continuous glass ribbon 170, thereby drawing the continuous glass ribbon 170 from the forming body 110 in the draw direction. It should be noted that while the present embodiments show the forming body 110 with respect to the fusion draw process, the forming body 110 may also include apparatus used to form glass using the slot draw process, float process or other similar downdraw processes. The plurality of pulling rolls 140 also help support a weight of the continuous glass ribbon 170, since during at least a portion of the separation cycle the portion of the continuous glass ribbon 170 below the plurality of pulling rolls 140 may be unsupported. Without a suitable pinching force, the plurality of pulling rolls 140 may be unable to apply a sufficient downward pulling force, or may be unable to support the portion of the continuous glass ribbon 170 below the plurality of pulling rolls 140 against the force of gravity.

Still referring to FIG. 2, the translatable separation initiation unit 150 includes a support portion 152, a sheet separating heating apparatus 154, and a flaw initiation device 156. The sheet separating heating apparatus 154 is coupled to the support portion 152. The sheet separating heating apparatus 154 includes a forming body heating element, such as a cartridge heater, a heating rod, a heating filament, a heating wire, heat tape, or the like. The sheet separating heating apparatus 154 extends perpendicular to the draw direction (see FIG. 3). While the sheet separating heating apparatus 154 extends perpendicular to the draw direction in the embodiment depicted in FIG. 3, it should be understood that in other embodiments, the sheet separating heating apparatus 154 may not extend perpendicular to the draw direction. For example, in some embodiments, the sheet separating heating apparatus 154 extends substantially parallel to the draw direction. In some embodiments, the sheet separating heating apparatus 154 extends at an angle between 0° and 90° relative to the draw direction.

Still referring to FIG. 2, in some embodiments, the sheet separating heating apparatus 154 is configured to contact the continuous glass ribbon 170 across at least a portion of a width of the continuous glass ribbon 170 (or across an entire width of the continuous glass ribbon 170) at a desired line of separation (“DLS”), thereby heating the continuous glass ribbon 170 at the desired line of separation to facilitate the separation of a glass sheet 175 from the continuous glass ribbon 170 below the desired line of separation. In some embodiments, the continuous glass ribbon 170 has cooled significantly from its temperature at the root 139 (which may be in the range of about 1000° C. to about 1200° C. in some embodiments) to its temperature immediately prior to being contacted by the sheet separating heating apparatus 154 (which may be in the range of about 300° C. to about 400° C. in some embodiments). In some embodiments, such as embodiments in which the sheet separating heating apparatus 154 extends perpendicular to the draw direction, the desired line of separation extends perpendicular to the draw direction across at least a portion of the width of the continuous glass ribbon 170. In some embodiments, such as embodiments in which the sheet separating heating apparatus 154 extends parallel or substantially parallel to the draw direction, the desired line of separation extends parallel or substantially parallel to the draw direction (e.g., to separate one or more edge portions or beads from the continuous glass ribbon 170). In some embodiments, such as embodiments in which the sheet separating heating apparatus 154 extends at an angle between 0° and 90° relative to the draw direction, the desired line of separation extends at the same angle (e.g., to separate angled glass sheets from the continuous glass ribbon 170). In some embodiments, the sheet separating heating apparatus 154 may not contact the continuous glass ribbon 170, such as when the sheet separating heating apparatus 154 heats the continuous glass ribbon 170 at the desired line of separation by a non-contact modality.

Some embodiments may not include the sheet separating heating apparatus 154, such as embodiments that only mechanically separate the glass sheet 175 from the continuous glass ribbon 170 such as by scoring the continuous glass ribbon 170 to separate the glass sheet 175.

Referring to FIG. 2, the flaw initiation device 156 is configured to initiate a flaw at the desired line of separation of the continuous glass ribbon 170. The flaw initiation device 156 may initiate a flaw at the desired line of separation before, during, or after the continuous glass ribbon 170 is heated at the desired line of separation as described herein. In some embodiments, the flaw initiation device 156 includes a scoring device. In embodiments that include the scoring device, the scoring device is configured to score the continuous glass ribbon 170 across at least a portion of the desired line of separation. In some embodiments, the scoring device scores the entire width of the desired line of separation. In other embodiments, the scoring device scores only a portion of the desired line of separation. For example, some embodiments may only score a bead region of the continuous glass ribbon 170 (i.e. a widthwise portion of the continuous glass ribbon 170 that extends across the draw to a distance from an edge of the continuous glass ribbon 170), a knurl region of the continuous glass ribbon 170 (i.e. a widthwise portion of the continuous glass ribbon 170 that extends across the draw and includes a knurled pattern as a result of contacting one or more pulling rollers), between a bead region and knurl region, etc. In some embodiments, a widthwise central portion of the continuous glass ribbon may include the glass core layer 172 disposed between the glass cladding layers 174a, 174b, while bead regions at the edges of the continuous glass ribbon may only include the glass core layer 172 and no glass cladding layers 174a, 174b. In some such embodiments, the flaw initiation device 156 may introduce a flaw in the glass core layer 172 of one more of the beads (which only include the glass core layer 172) at the desired line of separation. In some embodiments, the heat applied to the desired line of separation may direct the flaw across the desired line of separation.

In some embodiments in which the flaw initiation device 156 includes a scoring device, the scoring device scores a small width of the continuous glass ribbon 170 at the desired line of separation, such as in embodiments in which the scoring device scores a 100 mm or smaller width of the continuous glass ribbon 170 at an edge of the continuous glass ribbon 170. In some embodiments, the flaw initiation device 156 is configured to initiate a flaw at an edge of the continuous glass ribbon 170. In embodiments that mechanically score only a portion of the desired line of separation, a scoring wheel and/or other components of the scoring device may last longer, leading to cost savings realized from less frequent replacement of such components. Furthermore, in embodiments that mechanically scores only a portion of the desired line of separation, the scoring device may be less likely to strike a pre-existing crack in the ribbon, leading to a reduced likelihood of the negative consequences of the scoring device striking a pre-existing crack while scoring. In embodiments that heat the continuous glass ribbon 170 across the desired line of separation as described herein, edge flaws typical of mechanical scoring may be reduced.

In some embodiments, the flaw initiation device 156 includes at least one device other than a scoring device. For example, in some embodiments, the flaw initiation device 156 includes a laser, an ultrasonic transducer, a carbide tip, a diamond tip or stylus, a hot filament, a cooling apparatus, a heater (e.g., a silicon nitride heater), a drop or stream of fluid (e.g., water, air, etc.) or the like. In some embodiments, the flaw may be initiated by a drop of water applied by a damp object. In some embodiments, fluid (e.g., water, air, etc.) may be applied before, during, or after the flaw initiation device 156 initiates a flaw in the continuous glass ribbon 170 at the desired line of separation, in order to enhance the initiated flaw. In some embodiments, the flaw initiation device 156 may include a mechanical flaw initiation device (e.g., a scoring device, a tip or stylus, or the like) as well as an auxiliary heater, which may function to enhance separation as described herein.

Still referring to FIG. 2, the flaw initiation device 156 is positioned on the translatable separation initiation unit 150 relative to the sheet separating heating apparatus 154 such that the continuous glass ribbon 170 is disposed between the sheet separating heating apparatus 154 and the flaw initiation device 156 when the sheet separating heating apparatus 154 contacts the continuous glass ribbon 170. In other embodiments, the flaw initiation device 156 is positioned on the same side of the translatable separation initiation unit 150 as the sheet separating heating apparatus 154 such that the sheet separating heating apparatus 154 contacts a first side of the continuous glass ribbon 170 along the desired line of separation and the flaw initiation device 156 initiates a flaw in the first side of the continuous glass ribbon 170 at the desired line of separation. In some embodiments, the flaw initiation device 156 is included in the sheet separating heating apparatus 154. In some embodiments in which the sheet separating heating apparatus 154 includes the flaw initiation device 156, the flaw initiation device 156 is positioned at an end of the sheet separating heating apparatus 154 such that the flaw initiation device 156 is configured to introduce a flaw in an edge of the continuous glass ribbon 170 when the sheet separating heating apparatus 154 contacts the continuous glass ribbon 170.

Some embodiments do not include a flaw initiation device 156, such as embodiments in which a glass sheet separates from the continuous glass ribbon 170 at the desired line of separation as a direct result of heating the continuous glass ribbon 170 at the desired line of separation, or as a result of heating the continuous glass ribbon 170 at the desired line of separation and imparting a bending moment to the continuous glass ribbon 170 about the desired line of separation. In embodiments that do not include the flaw initiation device 156, significant savings can be realized in equipment and service as a result of not requiring the flaw initiation device 156 to initiate separation of a glass sheet from the continuous glass ribbon 170.

Some embodiments include an apparatus other than the translatable separation initiation unit 150 for separating the glass sheet 175 from the continuous glass ribbon 170. Examples include, but are not limited to scoring and bending the glass sheet 175 from the continuous glass ribbon 170, a laser, an ultrasonic transducer, a carbide tip, a diamond tip or stylus, a hot filament, a cooling apparatus, a heater (e.g., a silicon nitride heater), a drop or stream of fluid (e.g., water, air, etc.) or the like. In some embodiments, a mechanical separation may be performed using for example, a scoring device, a tip or stylus, or the like, as well as an auxiliary heater, which may function to enhance separation as described herein.

Now referring to FIGS. 2 and 3, the glass engaging unit 160 is shown engaged with the continuous glass ribbon 170. The glass engaging unit 160 may be engaged with the continuous glass ribbon 170 before, during or after the continuous glass ribbon 170 is heated with the sheet separating heating apparatus 154, and a flaw is initiated in the continuous glass ribbon 170 with the flaw initiation device 156, to separate the glass sheet 175 from the continuous glass ribbon 170. The glass sheet 175 is the portion of the continuous glass ribbon 170 that has been separated from the continuous glass ribbon 170 at the desired line of separation, as shown in FIG. 3.

Referring to FIG. 3, the glass engaging unit 160 bends the continuous glass ribbon 170 at an angle to separate the glass sheet 175 from the continuous glass ribbon 170. The bending may be performed in a clockwise or counter clockwise direction, as shown by the arrows in FIG. 3. In some embodiments, the glass engaging unit 160 bends the continuous glass ribbon 170 at the desired line of separation to a bend angle less than or equal to about 20°, less than or equal to about 15°, in the range from about 10° to about 20°, or in the range from about 10° to about 15°. Such bend angle ranges may be smaller than the approximately 25° bend angle that may be required to separate a glass sheet from a continuous glass ribbon not heated along the desired line of separation as described herein. Such a small bend angle may desirably result in better stability of the continuous glass ribbon 170 and decreased movement of the continuous glass ribbon 170 in the +Y and −Y directions upon separation of the glass sheet 175 from the continuous glass ribbon 170. In some embodiments, the glass engaging unit 160 may be configured as a robot, though embodiments are not limited thereto. In some embodiments, it may be desirable to separate the glass sheet from the continuous glass ribbon 170 within about 3-8 seconds from initially contacting the continuous glass ribbon 170 with the sheet separating heating apparatus 154.

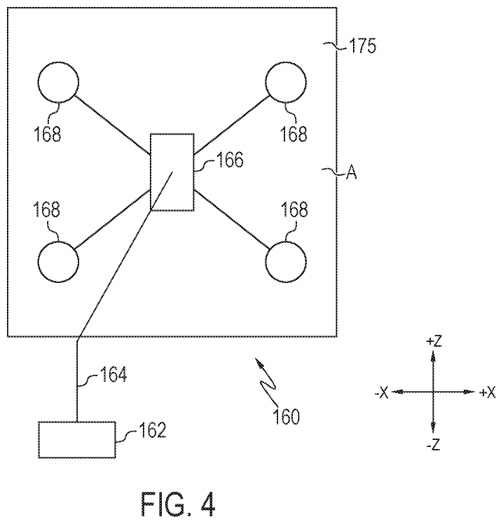

Referring now to FIG. 4, the glass engaging unit 160 is shown engaged with the glass sheet 175, after the glass sheet 175 is separated from the continuous glass ribbon 170. The glass engaging unit 160 includes a translatable body 162, at least one arm 164, a platform 166, and at least one suction device 168. The translatable body 162 may be configured to move on a floor (surface perpendicular to draw direction). In some embodiments, the translatable body 162 may have wheels to provide such movement. The at least one arm 164 extends from the translatable body 162. The at least one arm 164 allows the glass engaging unit 160 to perform top to bottom movements, left to right movements, and tilting movements. In certain embodiments, the glass engaging unit 160 is able to move in a +Y axis to −Y axis direction, a +X axis to −X axis direction, and +Z axis to −Z axis direction. The at least one arm 164 may be configured to be extendable, such that its length may be adjusted to increase or decrease as required. In some embodiments, the at least one arm 164 provides sufficient movement that the translatable body 162 can be omitted.

Still referring to FIG. 4, the platform 166 of the glass engaging unit 160 is positioned at a distal end of the at least one arm 164 and a proximal end of the at least one arm 164 is engaged with the translatable body 162. In certain embodiments, the platform 166 is engaged with the distal end of the at least one arm 164, wherein the at least one suction device 168 is attached to the platform 166. The at least one suction device 168 (e.g. suction cup) is arranged on the platform 166. In certain embodiments, only by way of example, about four suction devices 168 are used. The at least one suction device 168 is also placed at the distal end of the at least one arm 164 and is configured to engage with edge portions of the “A” surface (or a first side) of the glass ribbon. Briefly referring back to FIG. 3, the at least one arm 164 moves the platform 166 at a velocity vector Vra, while the glass engaging unit is still in contact with the continuous glass ribbon 170, such that it matches the velocity vector Vr of the continuous glass ribbon 170 such that the continuous glass ribbon 170, the translatable separation initiation unit 150 (including the sheet separating heating apparatus 154 and the flaw initiation device 156) and the platform 166 are all moving in tandem and there is no relative motion between them. In other words, the glass engaging unit 160 through the at least one arm 164 causes the platform 166 to track with the continuous glass ribbon 170. When the platform 166 is tracking with the continuous glass ribbon 170 so that no relative motion in the draw direction between the platform 166 and the continuous glass ribbon 170 is occurring, the at least one arm 164 moves the platform 166 such that the at least one suction device 168 engages with the continuous glass ribbon 170 below the desired line of separation. Referring to FIG. 4, the glass engaging unit 160 may be configured to rotate the platform 166 in a clockwise or counter-clockwise direction. By rotating the platform 166, the glass engaging unit 160 is also able to rotate the glass sheet 175, when the glass engaging unit 160 is engaged with the glass sheet 175.

In some embodiments, the glass engaging unit 160 may be a programmable robot. In embodiments, the glass engaging unit 160 may include one or more memory devices and one or more processors, where instructions may be stored in the memory, and executed by the processor to separate the glass sheet 175 from the continuous glass ribbon 170 beneath the forming body 110, and move the glass sheet 175 to the bead removal station 200. Various variables such as the bending angle to separate the glass sheet 175 from the continuous glass ribbon 170, the speed at which the glass sheet 175 is moved to the bead removal station 200, the number of suction devices 168 engaged by the glass engaging unit 160, and the like may be controlled by the programmable robot.

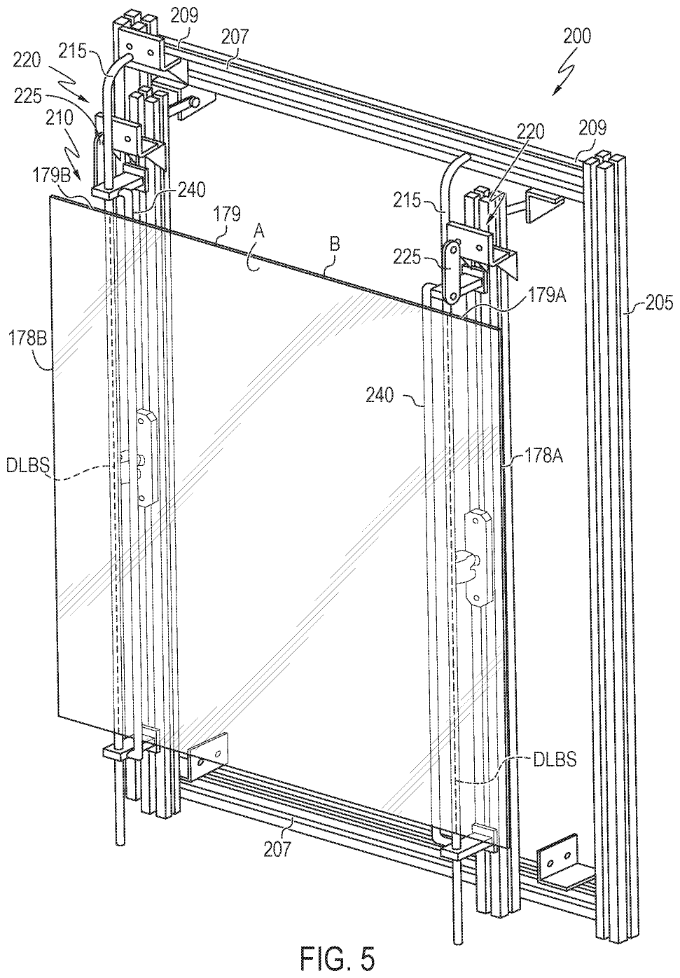

Now referring to FIG. 5, the bead removal station 200 with the glass sheet 175 in contact with the bead removal station 200 is shown. The glass engaging unit 160 has not been shown in this figure for clarity, although the glass sheet 175 will be held against the bead removal station 200, while the glass sheet 175 is in engagement with the glass engaging unit 160. In embodiments, the glass engaging unit 160 may be configured to hold the glass sheet 175 in a vertical or substantially vertical orientation (i.e. the glass sheet 175 is held against the bead removal station 200 along its length, as shown in FIG. 5) with respect to the bead removal station 200. In some embodiments, when the glass sheet 175 is vertically or substantially vertically oriented, the glass sheet 175 does not bend or break under its own weight. The bead removal station 200 includes the bead removal heating apparatus 210 and the crack initiation device 220. The bead removal station 200 is placed adjacent to, and laterally offset from the forming body 110. In some embodiments, the bead removal station 200 and the forming body 110 may be placed adjacent to each other without any intervening structures in between them. In other embodiments, the bead removal station 200 and the forming body 110 are placed at a distance within a range of about 1 foot to about 100 feet from each other. In some embodiments, the forming body 110 and the bead removal station 200 may be placed such that they are facing each other.

Still referring to FIG. 5, the bead removal station 200 includes a frame 205, such that the bead removal heating apparatus 210 and the crack initiation device 220 are coupled to the frame 205. The crack initiation device 220 may be placed above the bead removal heating apparatus 210 and mounted on the frame 205, as shown in FIG. 5. The bead removal heating apparatus 210 and the crack initiation device 220 are coupled to the frame 205 in such a way that the bead removal heating apparatus 210 and the crack initiation device 220 are movable relative to the frame 205. In embodiments, the bead removal heating apparatus 210 and the crack initiation device 220 are movable such that they are configured to slide within a set of grooves 207, the set of grooves 207 being within the frame 205. This sliding movement of the bead removal heating apparatus 210 and the crack initiation device 220 allows glass sheets 175 of various sizes to be de-beaded. In some embodiments, the crack initiation device 220 may be placed below the bead removal heating apparatus 210, and in other embodiments, the crack initiation device 220 may be placed both above and below the bead removal heating apparatus 210.

Referring to FIG. 5, the bead removal heating apparatus 210 is coupled to the frame 205, and includes a heating element 215. In some embodiments, two heating elements 215 may be used. In embodiments, a distance between the two heating elements 215 of the bead removal heating apparatus 210 is adjustable because the two heating elements 215 are moveable relative to the frame 205. In some embodiments, the heating elements 215 may be the same as the heating element of the sheet separating heating apparatus 154, although it is not necessary. In some embodiments, the heating element 215 may be a cartridge heater, a heating rod, a heating filament, a heating wire, heat tape, or the like. In embodiments, the heating element is placed parallel or substantially parallel to the draw direction (“D”) shown in FIG. 3. Such an arrangement allows the glass engaging unit 160 to move the glass sheet 175 from the forming body 110 to the bead removal station 200 without having to rotate the glass sheet 175 or set it down on a table. This arrangement allows the glass sheet 175 to be minimally cooled before the bead removal heating apparatus 210 heats the glass sheet 175 for de-beading. In some embodiments, the heating element 215 is placed perpendicular or substantially perpendicular to the draw direction. In such an arrangement, the glass engaging unit 160 is configured to rotate and orient the glass sheet 175 such that the heating element 215 aligns with a desired line of bead separation. In certain embodiments, the heating element 215 may be placed parallel or substantially parallel to the draw direction, perpendicular or substantially perpendicular to the draw direction, or any angle in between parallel and perpendicular to the draw direction. Depending on the angle at which the heating element 215 is placed relative to the draw direction, the glass engaging unit 160 may be configured to appropriately align the glass sheet 175 with respect to the heating element 215.

The heating element 215 is placed on the frame 205 such that the bead removal heating apparatus 210 contacts the glass sheet 175 at a second side (“B” surface) of the glass sheet 175, when the at least one suction device 168 of the glass engaging unit 160 is engaged with a first side (“A” surface) of the glass sheet 175. Specifically, the heating element 215 selectively heats the glass sheet 175 by contacting the glass sheet 175 on the second side at the desired line of bead separation. The desired line of bead separation (“DLBS”) is a line that extends longitudinally and is substantially parallel or parallel to a first edge 178A of the glass sheet 175. The heating element 215 selectively heats the glass sheet 175 at the desired line of bead separation by applying heat to the second side of the glass sheet at the desired line of bead separation without applying heat to the first side of the glass sheet and/or to a remote region of the glass sheet spaced away from the desired line of bead separation. In embodiments, the desired line of bead separation may be substantially parallel to the draw direction D. In other embodiments, the desired line of bead separation may be substantially perpendicular to the draw direction. In embodiments, the desired line of bead separation may be at an angle in between 0° and 180° as compared to the draw direction. The heating element 215 heats the glass sheet 175 at the desired line of bead separation to assist in the separation of at least one bead from the glass sheet 175, where the at least one bead is a longitudinal portion of the glass sheet 175 extending width wise from the first edge 178A of the glass sheet 175 to the desired line of bead separation. In some embodiments, the at least one bead is a longitudinal portion of the glass sheet 175 extending width wise from the first edge 178A of the glass sheet 175 to the desired line of bead separation, such that a thickness of the bead is greater than a thickness of a central region of the glass sheet 175. By heating the glass sheet 175 on the second side, at the desired line of bead separation, stresses in the glass sheet 175 are reduced. Specifically, with respect to strengthened glass laminates, the compressive stresses in the at least one cladding layer 174a, 174b and tension stresses in the glass core layer 172 are reduced in the areas at and surrounding the desired line of bead separation where heat is applied. This thereby allows de-beading of the glass sheet 175 at the desired line of bead separation without breaking or shattering the strengthened glass laminates.

In embodiments, the glass sheet 175 may have two desired lines of bead separation, where one line extends longitudinally and substantially parallel or parallel to the first edge 178A of the glass sheet 175, and the second line extends longitudinally and substantially parallel or parallel to a second edge 178B, the second edge 178B being opposite to the first edge 178A of the glass sheet 175. In some embodiments, when two beads (one on each edge 178A, 178B) of the glass sheet 175 are separated, two heating elements 215 may heat the second side of the glass sheet 175 at the desired lines of bead separation as shown in FIG. 5. The bead portion in FIG. 5 is therefore the portion that extends from the desired line of bead separation, indicated as a dotted line, to the first edge 178A of the glass sheet 175. The heating element 215 is configured to heat the glass sheet 175 to a temperature within a range of about 200° C. to about 800° C., or within a range of about 300° C. to about 700° C., or within a range of about 400° C. to about 600° C. Within this temperature range, the glass sheet 175 is heated, however, the glass sheet 175 does not melt (melting temperature of glass is generally between the range of about 1000° C. to about 1200° C. in some embodiments). In some embodiments, the bead removal heating apparatus 210 may not contact the glass sheet 175, such as when the bead removal heating apparatus 210 heats the glass sheet 175 at the desired line of bead separation by a non-contact modality.

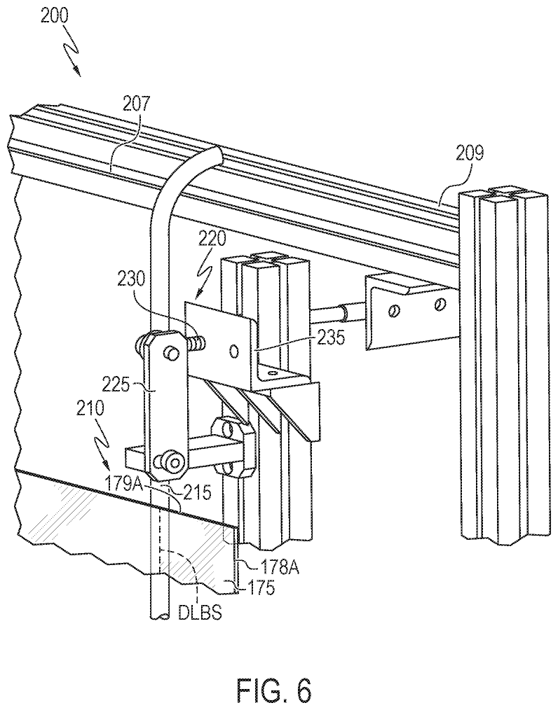

Now referring to FIGS. 5 and 6, the crack initiation device 220 is configured to initiate a crack at the desired line of bead separation of the glass sheet 175. The crack initiation device 220 may initiate a crack, before, during, or after the glass sheet 175 is heated at the desired line of bead separation, as described herein. In embodiments, the crack initiation device 220 is placed above the heating element 215. To initiate a crack a force is applied on the glass sheet to crack the glass sheet. In some embodiments, the crack initiation device 220 includes a metal piece 225 that is loaded with an engagement member 230 (for example, a spring) onto the frame 205 of the bead removal station 200, such that the engagement member (for example, the spring) 230 is configured to control a release of the metal piece 225. For example, the metal piece 225 is engaged with the spring 230 until tension in the spring 230 is released. Tension in the spring 230 may be released by pressing a button, manually or automatically. Once tension in the spring 230 is released, the spring 230 disengages or releases from the metal piece 225 such that the released metal piece 225 then strikes the glass sheet 175. To initiate the crack at the desired line of bead separation, the metal piece 225 is released such that it strikes a point 179A on a third edge 179 of the glass sheet 175 at the desired line of bead separation and initiates a crack in the glass sheet 175. The metal piece 225 along with the spring 230 is shown as placed on the frame 205 of the bead removal station 200. After the metal piece 225 strikes the glass sheet 175, the metal piece 225 may be re-engaged with the spring 230 to re-set the crack initiation device 220. In embodiments, the metal piece 225 may also be heated when the crack initiation device 220 contacts or strikes the glass sheet 175 at the desired line of bead separation to initiate the crack. In embodiments, the metal piece 225 may have a length within a range of about 1 cm to about 50 cm, or within a range of about 5 cm to about 25 cm, or within a range of about 7 cm to about 15 cm. The spring 230 may be attached with the metal piece 225 using nuts, bolts, or a similar type of attachment mechanism. In embodiments, the crack initiation device 220 may be attached to a support 235 such that the support 235 is able to slide along the grooves 207 of the frame 205 (e.g., with heating element 215).

In embodiments configured to separate two beads, another crack initiation device 220 with another metal piece 225 and another engagement member (for example, a spring) 230 may be placed proximate to 179B on the third edge 179 at the desired line of bead separation of the glass sheet 175, as shown in FIG. 5. In this case, two metal pieces 225 coupled to the frame 205, with one metal piece 225 on each end 209 of the frame 205 may be provided, as shown in FIG. 5. Both metal pieces 225 may be configured to strike the glass sheet 175 at the same time, or one after the other. In some embodiments, four crack initiation devices may be provided, where two crack initiation devices 220 are present above the heating elements 215 (as shown in FIG. 5), and two crack initiation devices 220 are present below the heating elements 215 (not shown). The four crack initiation devices 220 would be effective in de-beading two beads at the desired lines of bead separation. For example, the crack may be initiated from the top or the bottom edge of the glass sheet.

In some embodiments, the metal piece 225 may not be used in the crack initiation device 220. In some embodiments, the crack initiation device 220 may include, non-limiting examples such as scoring and bending the glass sheet 175 from the continuous glass ribbon 170, a laser, an ultrasonic transducer, a carbide tip, a diamond tip or stylus, a hot filament, a cooling apparatus, a heater (e.g., a silicon nitride heater), a drop or stream of fluid (e.g., water, air, etc.) or the like. In some embodiments, a mechanical separation may be performed using for example, a scoring device, a tip or stylus, or the like, as well as an auxiliary heater, which may function to enhance separation as described herein.

Referring to FIG. 5, the bead removal station 200 may also include a bead removal cooling apparatus 240 configured to contact the glass sheet 175 at the desired line of bead separation. In some embodiments, the bead removal cooling apparatus 240 may be placed adjacent to the at least one suction device 168 on the first side of the glass sheet 175, when the glass sheet 175 is engaged with the glass engaging unit 160. In embodiments that include the bead removal cooling apparatus 240, the bead removal cooling apparatus 240 may include a cold wire, a cold rod, a cold tube, or another cold element having a temperature less than the glass sheet 175. In some embodiments, the bead removal cooling apparatus 240 is actively cooled, such as by circulating cold water through the bead removal cooling apparatus. In other embodiments, the bead removal cooling apparatus 240 may be at ambient temperature. In certain embodiments, the bead removal cooling apparatus 240 may also be attached to the frame 205 of the bead removal station 200 such that the glass sheet 175 contacts the bead removal heating apparatus 210 at the second side (“B” surface) of the glass sheet 175, and the bead removal cooling apparatus 240 on the first side (“A” surface) of the glass sheet 175. In other embodiments, the bead removal cooling apparatus 240 may also contact the second side (“B” surface) of the glass sheet 175 after the bead removal heating apparatus 210 has contacted the second side of the glass sheet 175. In certain embodiments, the bead removal cooling apparatus 240 may contact the glass sheet 175 at the desired line of bead separation.

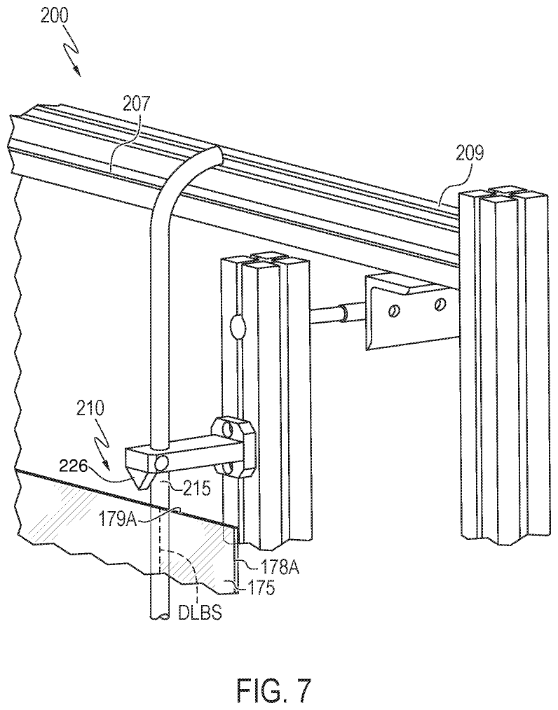

Referring to FIG. 7, the bead removal station 200 with the glass sheet 175 in contact with the bead removal station 200 is shown. The embodiments shown in FIG. 7 are similar to those shown in FIGS. 5-6, except that the crack initiation device 220 includes a wedge 226 in place of the metal piece 225. The glass sheet may be pressed against the wedge 226 to initiate the crack. In some embodiments, the glass engaging unit 160 is configured to press the glass sheet 175 against the wedge 226 (e.g., by moving the glass sheet relative to the wedge). Additionally, or alternatively, the wedge 226 may be movable to strike the glass sheet 175 (e.g., as described in reference to the metal piece 225). The wedge 226 may be sharp or pointed to concentrate force at a desired location on the glass sheet (e.g., the DLBS).

In various embodiments, it may be beneficial to move the crack initiation device 220 (e.g., by moving the metal piece 225 or the wedge 226) as opposed to moving the glass sheet 175 to initiate the crack. Such movement of the crack initiation device 220 instead of the glass sheet can reduce the potential for breaking the glass sheet as a result of movement against the heating element 215.

A method of separating at least one bead from a glass sheet will now be described.

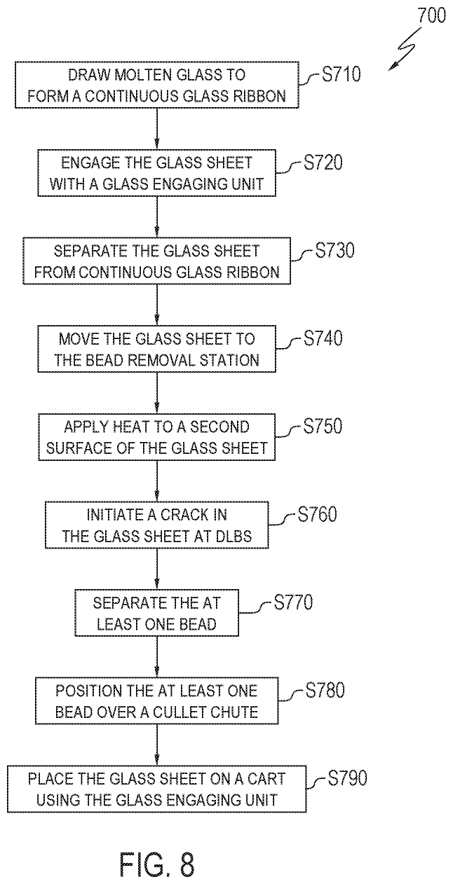

Referring to FIGS. 2 and 8, at step S710, molten glass is drawn in a draw direction from the forming body 110 by the plurality of pulling rolls 140 to form the continuous glass ribbon 170. The translatable separation initiation unit 150 which includes the sheet separating heating apparatus 154 and the flaw initiation device 156 heat the continuous glass ribbon 170 and initiate a flaw within the continuous glass ribbon 170, as the continuous glass ribbon 170 moves in the draw direction. The translatable separation initiation unit 150 contacts and heats the continuous glass ribbon 170 at the desired line of separation, which extends laterally across the draw in a direction perpendicular to the draw direction.

Still referring to FIGS. 3 and 8, at step S720, the continuous glass ribbon 170 is engaged with a glass engaging unit 160. The glass engaging unit engages with a first side (“A” surface) of the continuous glass ribbon 170. In some embodiments, the glass engaging unit 160 may be engaged with the continuous glass ribbon 170 before, during, or after the translatable separation initiation unit 150 contacts the continuous glass ribbon 170. In embodiments, the glass engaging unit 160 may engage with the continuous glass ribbon 170 after the sheet separating heating apparatus 154 has heated the continuous glass ribbon 170, and before a flaw has been initiated by the flaw initiation device 156. In some embodiments, the glass engaging unit 160 may engage with the continuous glass ribbon 170 after the sheet separating heating apparatus 154 has heated the continuous glass ribbon 170, and after a flaw has been initiated by the flaw initiation device 156. The glass engaging unit 160 contacts the continuous glass ribbon 170 at the first side (“A” surface) using the at least one suction device 168. The at least one arm 164 of the glass engaging unit 160 may extend to a pre-determined height such that the placement of the at least one suction device 168 on the continuous glass ribbon 170 allows a minimum distance to be maintained between the at least one suction device 168 and the translatable separation initiation unit 150. In certain embodiments, the at least one suction device 168 of the glass engaging unit 160 may be spaced apart from the sheet separating heating apparatus 154 by about 150 mm.

Now referring to FIGS. 4 and 8, at step S730, a glass sheet 175 is separated from the continuous glass ribbon 170 such that the glass sheet 175 is in engagement with the glass engaging unit 160. The glass sheet 175 is separated at a desired line of separation from the continuous glass ribbon 170. In some embodiments, separating the glass sheet 175 from the continuous glass ribbon 170 may include initiating a flaw at the desired line of separation with the flaw initiation device 156 described above. In some embodiments, the flaw initiation device 156 may be a scoring device that scores the continuous glass ribbon 170 at the desired line of separation. Additionally, separating the glass sheet 175 from the continuous glass ribbon 170 may also include bending the continuous glass ribbon 170 at an angle using the at least one arm 164 of the glass engaging unit 160. In embodiments that heat the continuous glass ribbon 170 at the desired line of separation as described herein, the angle at which the glass engaging unit 160 bends the continuous glass ribbon 170 to separate the glass sheet from the continuous glass ribbon 170 may be reduced, thereby mitigating post-separation motion imparted to the remainder of the continuous glass ribbon 170. In embodiments, when the glass sheet 175 is in engagement with the glass engaging unit 160, the at least one suction device 168 may be placed within a range of about 10 mm to about 200 mm from edges 178A, 178B and 179 of the glass sheet 175.

Now referring to FIGS. 1 and 8, at step S740, the glass sheet 175 is moved to a bead removal station 200 while the glass sheet 175 is engaged with the glass engaging unit 160. The bead removal station 200 is adjacent to, and laterally offset from the forming body 110. In moving the glass sheet 175 from the forming body 110 to the bead removal station 200, the glass engaging unit 160 may move along the distance between the forming body 110 and the bead removal station 200 using its translatable body 162. In some embodiments, the glass sheet 175 may be moved from the forming body 110 to the bead removal station 200 by the glass engaging unit 160 by extending the at least one arm 164 to the bead removal station 200 with or without moving the translatable body 162. The glass engaging unit 160 may be configured to move the glass sheet 175 from the forming body 110 to the bead removal station 200 at a pre-determined speed. This speed may be determined such that the glass sheet 175 is moved with minimum time delays to the bead removal station 200 so that the glass sheet 175 does not cool significantly. This ensures de-beading of the glass sheet 175 with minimal shattering or damage. In some embodiments, the glass engaging unit 160 may rotate the glass sheet 175 to an angle within the range of about 2° to about 359°, or about 90° to about 270°, or about 60° to about 90° as compared to the continuous glass ribbon 170 using the platform 166 of the glass engaging unit 160. The glass engaging unit 160 may rotate the glass sheet 175 before, during or after the glass sheet 175 is moved to the bead removal station 200. Rotation of the glass sheet allows for proper alignment of the glass sheet 175 with the bead removal station 200.

Referring to FIGS. 1 and 8, at step S750 after the glass sheet 175 is moved to the bead removal station 200, heat is applied selectively to a second side (“B” surface) of the glass sheet 175 at the desired line of bead separation while the glass sheet 175 is engaged with the glass engaging unit 160. The desired line of bead separation is a line that extends substantially parallel or parallel to a first edge 178A of the glass sheet, wherein the at least one bead is a longitudinal portion of the glass sheet 175 extending width wise from the first edge 178A of the glass sheet 175 to the desired line of bead separation. In embodiments, the desired line of bead separation may be substantially parallel or parallel to the draw direction D. Heat is applied using the bead removal heating apparatus 210 at the desired line of bead separation. In embodiments, heat is selectively applied such that only the desired line of bead separation of the glass sheet 175 is heated. In embodiments, the bead removal heating apparatus 210 may directly or indirectly contact the second side of the glass sheet 175 at the desired line of bead separation. In some embodiments, the positioning of the bead removal heating apparatus 210 with respect to the glass sheet 175 may be adjusted using the frame 205, on which the bead removal heating apparatus 210 is placed such that glass sheets 175 having different sizes (and therefore different lines of bead separation) may be accommodated at the same bead removal station 200. The bead removal heating apparatus 210 which includes the heating element 215 may be placed in a direction substantially parallel or parallel to the draw direction (i.e. in a vertical or substantially vertical direction) such that the heating element 215 extends along a length of the glass sheet 175, and therefore along the desired line of bead separation. The heating element 215 is configured to heat the glass sheet 175 to a temperature within a range of about 200° C. to about 800° C., and or within a range of 300° C. to about 700° C., or within a range of about 400° C. to about 600° C. Within this temperature range, the glass sheet 175 is heated, however, the glass sheet 175 does not melt (melting temperature of glass is generally between in the range of about 1000° C. to about 1200° C. in some embodiments). In embodiments where two beads are separated, heat is applied to the second side of the glass sheet with the heating elements 215 of the bead removal heating apparatus 210 at two desired lines of bead separation. As shown in FIG. 5 the bead removal heating apparatus 210 may include two heating elements 215, to heat the glass sheet 175 along the two desired lines of bead separation. In embodiments, a distance between the two heating elements 215 may be adjusted using the frame 205 of the bead removal station 200.

Referring to FIGS. 6 and 8, at step S760, a crack is initiated at the desired line of bead separation while the glass engaging unit 160 is engaged with the glass sheet 175. Specifically, the glass engaging unit 160 is engaged with a first side (“A” surface) of the glass sheet such that the second side (“B” surface) of the glass sheet 175 is engaged with the crack initiation device 220 at the bead removal station 200. For example, the crack is initiated with the crack initiation device 220. In some embodiments, a crack is initiated at 179A of a third edge 179 of the glass sheet 175 at the desired line of bead separation. In some embodiments, a crack is initiated at the desired line of bead separation at a location spaced apart from the third edge 179 at 179A. In embodiments, the crack initiation device 220 may strike or contact the glass sheet 175 after the bead removal heating apparatus 210 has heated the glass sheet 175 while the glass engaging unit 160 is engaged with the glass sheet 175. In some embodiments, the crack initiation device 220 may strike or contact the glass sheet 175 before the bead removal heating apparatus 210 has heated the glass sheet 175. In embodiments, the heating step (S750) and the cracking step (S760) may be carried out simultaneously. The crack initiation device 220 includes a metal piece 225 which is spring loaded with an engagement member (for example, a spring) 230 onto the frame 205 and/or a wedge 226. In some embodiments, the crack initiation device 220 may be configured such that the metal piece 225 and/or the wedge 226 strikes at 179A at the third edge 179 of the glass sheet 175 at the desired line of bead separation two or more times. For example, the metal piece 225 and/or the wedge 226 can be released to strike the edge 179 and/or the glass sheet can be moved to contact the metal piece 225 and/or the wedge 226. In embodiments where two beads are separated, the bead removal station 200 may have at least two crack initiation devices 220 provided on the frame 205 to initiate cracks at 179A and 179B of the third edge 179 at the desired lines of bead separation of the glass sheet 175. The cracks are initiated such that the metal pieces 225 of the crack initiation device 220 may strike the glass sheet 175 at 179A and 179B of the third edge 179 at the desired lines of bead separation.

Referring to FIGS. 1 and 8, at step S770, the at least one bead is separated from the glass sheet 175 at the desired line of bead separation at the bead removal station 200 while the glass sheet 175 is engaged with the glass engaging unit 160. The separation of the at least one bead may occur due to the combination of applying heat to the glass sheet 175 and initiating a crack in the glass sheet 175 at the desired line of bead separation. In some embodiments, an external force may be required to separate the at least one bead from the glass sheet 175. The external force may be an operator, or mechanical arm that bends the bead around the desired line of bead separation. In some embodiments, the glass engaging unit 160 itself may be configured to perform a vibrating movement or other mechanical movement while it is engaged with the glass sheet 175 that could cause the at least one bead to separate from the glass sheet 175. After the at least one bead is separated at the desired line of bead separation, the glass core layer 172, and the glass cladding layers 174a, 174b of the glass sheet 175 may be exposed. In embodiments, where two desired lines of bead separation may be present, two beads may be separated simultaneously or one after the other.

Referring to FIG. 8, at step S780 the separated at least one bead is positioned over a cullet chute 180. The cullet chute 180 is a sloping channel or slide that is used to convey the at least one bead to another location. In some embodiments, the cullet chute 180 may be located adjacent to, laterally offset from, or below the bead removal station 200. In embodiments, the separation of the at least one bead at the bead removal station may be performed in a manner that the at least one bead directly falls into the cullet chute 180 after being separated from the glass sheet 175. Further, still referring to FIG. 7, at step S790 the glass sheet 175 is placed on a cart 182 using the glass engaging unit 160. The glass sheets 175 after being placed on the cart 182 may be wheeled away for further packaging or processing.

In an alternative embodiment, a method for separating at least one bead from a glass sheet 175 includes drawing molten glass in a draw direction D to form a continuous glass ribbon 170 at a forming body 110. The continuous glass ribbon 170 is engaged with a glass engaging unit 160 at a first side (“A” surface). Additionally, the method includes separating the glass sheet 175 from the continuous glass ribbon 170 such that the glass sheet 175 is engaged with the glass engaging unit 160 at the first side of the glass sheet 175. The engagement of the glass sheet 175 with the glass engaging unit 160 is maintained by the at least one suction device 168 of the glass engaging unit 160. In some embodiments, the glass engaging unit 160 may rotate the glass sheet 175 to an angle within the range of about 90° to about 270°, as compared to the continuous glass ribbon 170. For example, the glass sheet 175 is rotated using the platform 166 of the glass engaging unit 160. The glass sheet 175 is moved to a bead removal station 200 while the glass sheet 175 is engaged with the glass engaging unit 160. The bead removal station 200 is placed adjacent to, and laterally offset from the forming body 110. At the bead removal station 200, heat is applied selectively to a desired line of bead separation of the glass sheet 175 with a bead removal heating apparatus 210. The bead removal heating apparatus 210 may include the heating element 215, in some embodiments, a heating rod placed substantially parallel or parallel to the draw direction D. The bead removal heating apparatus 210 may be configured to selectively heat the glass sheet 175 to a temperature within a range of about 400° C. to about 600° C. along the desired line of bead separation. In some embodiments, the glass sheet 175 is a strengthened glass laminate. In these embodiments, selective heating at the desired line of bead separation reduces a compressive stress in at least one cladding layer 174a, 174b of the glass sheet 175, thereby making it easier to de-bead strengthened glass laminates. Additionally, the method includes initiating a crack in the glass sheet 175 at the desired line of bead separation with a crack initiation device 220, the desired line of bead separation being a line that extends substantially parallel or parallel to a first edge 178A of the glass sheet 175, such that the at least one bead is a longitudinal portion of the glass sheet 175 extending width wise from the first edge 178A of the glass sheet 175 to the desired line of bead separation. In some embodiments, the method includes initiating the crack in the glass sheet 175 with the crack initiation device 220 after applying heat to a second side (“B” surface) with the bead removal heating apparatus 210, and then separating the at least one bead from the glass sheet 175 while the glass sheet 175 is engaged with the glass engaging unit 160. In embodiments, the selective heating at the desired line of bead separation reduces a compressive stress in at least one cladding layer 174a, 174b of the glass sheet 175. Further, in embodiments, the at least one bead is positioned over a cullet chute 180 to collect such beads after separation from the glass sheet 175. The glass sheet 175 after de-beading can be placed on a cart 182 using the glass engaging unit 160. The glass sheets 175 after being placed on the cart 182 may be wheeled away for further packaging or processing.

It should now be understood that the bead removal apparatuses and method for separating beads from glass sheets using glass engaging units produce de-beaded glass sheets with enhanced edge quality, reduced vertical cracking, and reduced warping, as compared to glass sheets that are de-beaded by conventional separation techniques.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents

1. A bead removal apparatus comprising:
a forming body from which a continuous glass ribbon is drawn in a draw direction;
a bead removal station adjacent to and laterally offset from the forming body, the bead removal station comprising:
a heating element configured to heat a desired line of bead separation of a glass sheet to a temperature within a range of about 400° C. to about 600° C.; and
a crack initiation device configured to initiate a crack in the glass sheet at the desired line of bead separation; and
a glass engaging unit configured to move the glass sheet from the continuous glass ribbon to the bead removal station.

2. The bead removal apparatus of claim 1, wherein the crack initiation device further comprises:
a metal piece positioned above the heating element; and
a spring coupled to the metal piece and configured to control a release of the metal piece, wherein the metal piece is configured to be released such that it strikes a third edge of the glass sheet at the desired line of bead separation and cracks the glass sheet.

3. The bead removal apparatus of claim 1, wherein the glass engaging unit comprises:
at least one arm;
at least one suction device;
a translatable body; and
a platform engaged with a distal end of the at least one arm, wherein the at least one suction device is attached to the platform, and the glass engaging unit is configured to impart a bending movement, a top to bottom movement, a left to right movement and a tilting movement.

4. The bead removal apparatus of claim 1, wherein the desired line of bead separation extends substantially parallel to a first edge of the glass sheet, and wherein the at least one bead is a longitudinal portion of the glass sheet extending width wise from the first edge of the glass sheet to the desired line of bead separation.

5. The bead removal apparatus of claim 1, further comprising a frame, the heating element and the crack initiation device coupled to the frame and movable relative to the frame.

6. The bead removal apparatus of claim 5, wherein the heating element comprises two heating elements and a distance between the two heating elements is adjustable.

7. The bead removal apparatus of claim 1, wherein the desired line of bead separation comprises two desired lines of bead separation, and the heating element comprises two heating elements each configured to heat one of the two desired lines of bead separation of the glass sheet to a temperature within the range of about 400° C. to about 600° C.

8. The bead removal apparatus of claim 7, wherein the crack initiation device comprises two crack initiation devices, each configured to initiate the crack in the glass sheet at one of the two desired lines of bead separation.

9. A method of separating at least one bead from a glass sheet, the method comprising:
drawing molten glass in a draw direction to form a continuous glass ribbon at a forming body;
engaging the continuous glass ribbon with a glass engaging unit;
separating the glass sheet from the continuous glass ribbon such that the glass sheet is engaged with the glass engaging unit;
moving the glass sheet to a bead removal station while glass sheet is engaged with the glass engaging unit, the bead removal station adjacent to and laterally offset from the forming body; and
separating the at least one bead from the glass sheet at a desired line of bead separation at the bead removal station while the glass sheet is engaged with the glass engaging unit.

10. The method of claim 9, wherein:
the separating the glass sheet from the continuous glass ribbon comprises separating the glass sheet from the continuous glass ribbon such that a first side of the glass sheet is engaged with the glass engaging unit; and
the separating the at least one bead comprises:
selectively applying heat to the desired line of bead separation at a second side of the glass sheet with a bead removal heating apparatus while the glass sheet is engaged with the glass engaging unit; and
initiating a crack in the glass sheet with a crack initiation device at the desired line of bead separation to separate the at least one bead from the glass sheet while the glass sheet is engaged with the glass engaging unit, wherein the desired line of bead separation extends substantially parallel to a first edge of the glass sheet, and wherein the at least one bead is a longitudinal portion of the glass sheet extending width wise from the first edge of the glass sheet to the desired line of bead separation.

11. The method of claim 10, wherein the initiating the crack comprises initiating the crack in the glass sheet with the crack initiation device after the selectively applying heat to the desired line of bead separation at the second side of the glass sheet with the bead removal heating apparatus.

12. The method of claim 10, wherein the bead removal heating apparatus comprises a heating rod placed substantially parallel to the draw direction.

13. The method of claim 10, wherein initiating the crack further comprises:
releasing a metal piece to strike a third edge of the glass sheet at the desired line of bead separation and cracking the glass sheet, wherein the crack initiation device comprises the metal piece and a spring coupled to the metal piece.

14. The method of claim 10, wherein the separating the at least one bead comprises:
applying heat selectively to the second side of the glass sheet with two heating elements at two desired lines of bead separation;
initiating cracks at the two desired lines of bead separation of the glass sheet with two crack initiation devices; and
separating two beads from the glass sheet.

15. The method of claim 14, further comprising:
adjusting a distance between the two bead removal heating elements at the bead removal station.

16. The method of claim 10, wherein the glass engaging unit is engaged with a first side of the glass sheet such that the second side of the glass sheet is engaged with the crack initiation device at the bead removal station.

17. A method of separating at least one bead from a glass sheet, the method comprising:
drawing molten glass in a draw direction to form a continuous glass ribbon at a forming body;
engaging the continuous glass ribbon with a glass engaging unit;
separating the glass sheet from the continuous glass ribbon such that the glass sheet is engaged with the glass engaging unit;
moving the glass sheet to a bead removal station while the glass sheet is engaged with the glass engaging unit, the bead removal station adjacent to and laterally offset from the forming body;
applying heat selectively to the glass sheet with a bead removal heating apparatus at the bead removal station, the bead removal heating apparatus comprising a heating element to heat the glass sheet to a temperature within a range of about 400° C. to about 600° C., the heating element placed substantially parallel to the draw direction; and
initiating a crack in the glass sheet at a desired line of bead separation with a crack initiation device placed above the heating element at the bead removal station, wherein the desired line of bead separation extends substantially parallel to an edge of the glass sheet;
wherein the at least one bead is a longitudinal portion of the glass sheet extending width wise from the edge of the glass sheet to the desired line of bead separation.

18. The method of claim 17, further comprising:
initiating the crack in the glass sheet with the crack initiation device after applying heat selectively to a first side of the glass sheet with the bead removal heating apparatus, at the desired line of bead separation; and
separating the at least one bead from the glass sheet while the glass sheet is engaged with the glass engaging unit,
wherein the selective heating at the desired line of bead separation reduces a compressive stress in at least one cladding layer of the glass sheet.

19. The method of claim 17, further comprising:
rotating the glass sheet to an angle within the range of about 90° to about 270° as compared to the continuous glass ribbon.

20. The method of claim 17, further comprising:
placing the glass sheet on a cart using the glass engaging unit after the at least one bead is separated from the glass sheet; and
positioning the at least one bead separated from the glass sheet over a cullet chute located adjacent to or below the bead removal station.
